(19) United States
(12) Patent Application Publication
(10) Pub. No.: US 2009/0295788 A1
(43) Pub. Date: Dec. 3, 2009

(54) VISUALLY EMPHASIZING PERIPHERAL PORTIONS OF A USER INTERFACE

(75) Inventors: RICHARD DUNCAN, KIRKLAND, WA (US); LATIKA KIRTANE, SEATTLE, WA (US); STEPHAN HOEFNAGELS, SEATTLE, WA (US); PATRICE L. MINER, KIRKLAND, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, REDMOND, WA (US)

(21) Appl. No.: 12/132,379

(22) Filed: Jun. 3, 2008

(51) Int. Cl. G06F 17/00

(52) U.S. Cl. 345/418

(57) ABSTRACT

Methods and computer-readable media for visually emphasizing small and typically unnoticed portions of a user interface are provided. A user indicates a desire to modify or customize certain settings for a particular portion of a user interface by, for example, opening a control panel window. Portions that can be modified or customized include a toolbar, taskbar, or system tray. The portion may be magnified or highlighted to draw the user's attention to that area, and any modifications that the user makes to that portion may be immediately displayed on the emphasized portion, which establishes a clear visual association between a set of configuration options for the portion of the user interface, and the portion itself. The portion may be emphasized at different times, such as when the configuration settings are displayed, when the user makes a change, or after the changes have been made.

### BACKGROUND

There are presently limited mechanisms for drawing a user's attention to certain portions of a user interface, such as toolbars, notification areas (e.g., system trays), and application desktop bars (e.g., taskbars). Further, there are limited mechanisms for drawing a user's attention, in a non-distracting way, to small icons on a user interface, such as icons in toolbars, notification areas, and application desktop bars. Traditionally, it has been a difficult task for a user to associate changes being made to a portion of a user interface, and to that portion itself. A user may make modifications to an area of a user interface using a control panel, for example. While the user is making these modifications, the user is typically unable to see the effects of these changes until all changes have been made, and the user has closed the control panel. If those changes are not acceptable to the user, the user must reopen the control panel and make further modifications.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention relate to bringing visual emphasis to reduced size portions of a total available area of a user interface. These embodiments provide a clear visual association between a set of customization options that may be modified by a user, and a portion of the user interface that the user desires to modify. The specified portion may be magnified or highlighted while modifications are made, so that the modifications are immediately displayed on the emphasized view of the specified portion. In other embodiments, a method is provided for bringing visual emphasis to reduced size icons by applying a surrounding emphasizing indicia, such as a backdrop glow, to a reduced size icon. The surrounding emphasizing indicia is applied to a reduced size icon when a pre-determined level of state change of the corresponding system, application, or program has been reached.

### BRIEF DESCRIPTION OF THE DRAWINGS

Embodiments of the present invention are described in detail below with reference to the attached drawing figures, wherein:

FIG. 1 is a block diagram of an exemplary computing environment suitable for use in implementing the present invention;

FIG. 2 is a flow diagram of a method for bringing visual emphasis to reduced size portions of a total available area of a user interface, in accordance with an embodiment of the present invention;

FIG. 3 is a flow diagram of a method for bringing visual emphasis to reduced size portions of a total available area of a user interface, in accordance with an embodiment of the present invention;

FIG. 4 is an illustrative screen display of an exemplary user interface showing customization of a notification area and a corresponding magnified notification area, in accordance with an embodiment of the present invention;

FIG. 5 is a flow diagram of a method for bringing visual emphasis to a reduced size icon, in accordance with an embodiment of the present invention;

FIG. 6 is an illustrative screen display of an exemplary user interface showing a notification area with a reduced size icon having a surrounding emphasizing indicia resulting from a pre-determined level of state change, in accordance with an embodiment of the present invention;

FIG. 7 is an enlarged view of a portion of the illustrative screen display of FIG. 6, illustrating a notification area with a reduced size icon having a surrounding emphasizing indicia, in accordance with an embodiment of the present invention;

FIG. 8 is an enlarged view of a portion of an illustrative screen display illustrating a notification area with a reduced size icon having a surrounding emphasizing indicia, in accordance with an embodiment of the present invention; and

FIG. 9 is an enlarged view of a portion of an illustrative screen display illustrating a notification area with a reduced size icon having a surrounding emphasizing indicia, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention relate to methods for bringing visual emphasis to small areas or reduced size icons on a user interface. The small areas on a user interface may include, but are not limited to, a toolbar, an application desktop bar (e.g., taskbar), or a notification area (e.g., system tray). Reduced size icons may include any icons on a user interface, such as, but not limited to icons on a toolbar, application desktop bar, or notification area.

More specifically, embodiments of the present invention provide methods for visually emphasizing specified portions and reduced size icons on a user interface. In one aspect, a computer-implemented method for bringing visual emphasis to reduced size portions of a total available area of a user interface is provided. The method includes receiving an indication to configure a specified portion of the user interface, displaying on the user interface a set of configuration options for the specified portion, and visually emphasizing the specified portion of the user interface, wherein visually emphasizing the specified portion comprises one or more of magnifying in size the specified portion, highlighting the specified portion, or highlighting an area around the specified portion, and wherein visually emphasizing the specified portion creates an emphasized portion. In addition, a configuration selection is received for the specified portion of the user interface, and the emphasized view of the specified portion is displayed with effects of the configuration selection.

In another aspect, a computer-implemented method for bringing visual emphasis to a reduced size icon is provided. The method includes listening for a state change associated with one or more reduced size icons on a user interface, and upon reaching a pre-determined level of change, applying a surrounding emphasizing indicia to the one or more reduced size icons.

In yet another aspect, one or more computer-readable media having computer-executable instructions embodied thereon that, when executed, perform a method for bringing visual emphasis to reduced size portions of a total available area of a user interface is provided. The method includes receiving a user indication to configure one or more specified portions of the user interface, and displaying on the user interface a set of configuration options for the one or more specified portions of the user interface. Incident to displaying the set of configuration options for the one or more specified portions of the user interface, the one or more specified portions of the user interface are magnified in size. The method further includes receiving one or more configuration selections for the one or more specified portions of the user interface. Incident to receiving the one or more configuration selections, the method includes displaying in the one or more specified portions effects of the one or more configuration selections. Further, the method includes receiving the user indication to complete configuration of the one or more specified portions of the user interface, and reverting the size of the one or more specified portions to an original size.

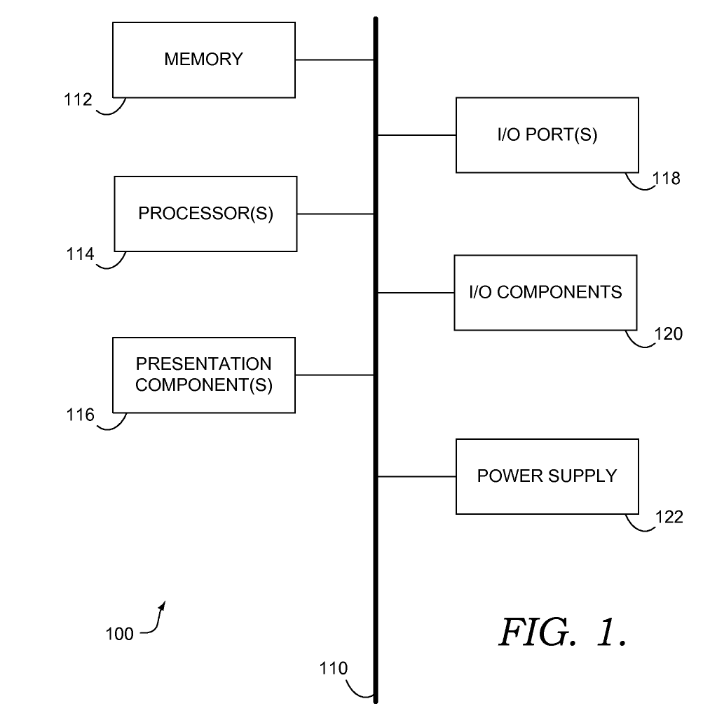

Having briefly described an overview of exemplary embodiments of the present invention, an exemplary operating environment for the present invention is now described. Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing environment 100 be interpreted as having any dependency or requirement relating to any one or combination of components/modules illustrated.

The invention may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. Embodiments of the present invention may be practiced in a variety of system configurations, including hand-held devices, consumer electronics, general-purpose computers, specialty computing devices, etc. Embodiments of the invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display to be an I/O component. Also, processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computer” or “computing device.”

Computer 110 typically includes a variety of computer-readable media. Computer-readable media can be any available media that can be accessed by computer 110 and includes both volatile and nonvolatile media, removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110.

Memory 112 includes computer-storage media in the form of volatile and/or nonvolatile memory. The memory may be removable, non-removable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display, speaker, printing component, vibrating component, etc.

I/O ports 118 allow computing device 100 to be logically coupled to other devices, including I/O components 120, some of which may be built in. Illustrative components include a microphone, joystick, game pad, satellite dish, scanner, printer, wireless device, etc.

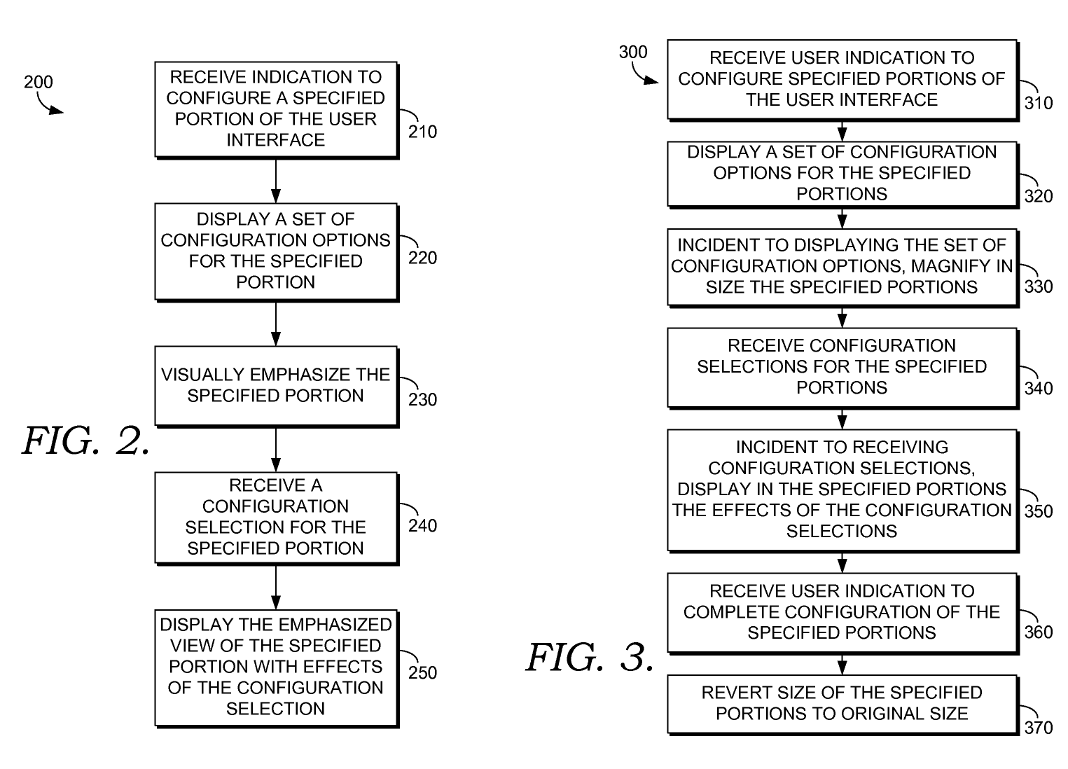

Referring now to FIG. 2, a flow diagram is illustrated that shows a method 200 for bringing visual emphasis to reduced sized portions of a total available area of a user interface, in accordance with an embodiment of the present invention. Initially, an indication to configure a specified portion of the user interface is received at step 210. This indication may come from, for example, a user, who may wish to modify settings for a specified portion of the user interface. Configuring a specified portion may include, but is not limited to, modifying or customizing. A specified portion of the user interface may include any portion that is able to be modified or customized, such as, but not limited to, a notification area (e.g., system tray), an application desktop bar (e.g., taskbar), or any other area that has icons or buttons (e.g., toolbar). In many cases, areas such as these are small compared to the overall size of a user interface and therefore, may not be easily noticed by a user. A notification area, such as a system tray, is typically located at or near the bottom of a user interface, and contains mainly icons that convey status information. Icons in this notification area may represent, for example, a clock, a printer, available network connections, virus protection software, audio status of the computing device, etc. These icons typically convey status information in real-time.

An application desktop bar is used to launch and monitor various applications for a particular computing device. A typical example of an application desktop bar is a taskbar, which is usually located at or near the bottom of a computing display, but can be located anywhere on the display, or can even be hidden and not visible on the display at all. A taskbar may contain an icon or button for at least a portion of the applications running on that particular computing device at a particular time. A user may switch between applications by selecting the icon that corresponds to the application or instance of an application that the user wishes to view. For example, a user may wish to customize a taskbar, which may be located at the bottom of the user interface. A user may be able to customize the taskbar in many ways, including locking or unlocking the taskbar, hiding at least a portion of the taskbar from the user interface, removing at least a portion of the tasks associated with the taskbar so that some are hidden or even combined with other tasks (e.g., gloming), changing the position of the taskbar on the display, resizing the height or width of the taskbar, etc.

A toolbar is a panel on which onscreen buttons, icons, menus or other input or output elements are placed. Toolbars may be customized in a variety of ways to meet a user's particular needs. Toolbars may be associated with various applications (e.g., Microsoft® Word, Microsoft® OUTLOOK, a product of Microsoft Corporation of Redmond, Wash.), including Internet applications (e.g., INTERNET EXPLORER, an internet browser of Microsoft Corporation of Redmond, Wash., MSN, a network of internet services of Microsoft Corporation of Redmond, Wash., WINDOWS LIVE, a network of internet services of Microsoft Corporation of Redmond, Wash.).

In some embodiments, the specified portion may not be visible to the user when the user is customizing it. For instance, certain icons in the notification area (e.g., system tray) may not always be visible to the user, especially if there are a large number of them. In these embodiments, the user may still configure, or customize the notification area even when many of the icons are not visible at that time. In another instance, certain items in a menu bar, such as the least frequently used items, may not appear in the menu, or may not be selectable. These may, however, be configured.

At step 220, a set of configuration options for the specified portion is displayed on the user interface. A set of configuration options may display the current configuration of the specified portion, and may also include setting options or customization options that a user may select. For instance, a set of configuration options may be viewed by selecting (e.g., right clicking) a portion of a taskbar that is not covered by an icon. This may allow a user to change the position of the taskbar, for example. In another instance, a set of configuration options may be viewed by opening a control panel, which may include configuration settings for many aspects of a computing device, including the taskbar, toolbar, system tray, menu lists, as well as many others.

The specified portion of the user interface is visually emphasized at step 230 to create an emphasized view of the specified portion. Visually emphasis may include, but is not limited to magnifying the specified portion highlighting the specified portion, or highlighting an area surrounding the specified portion. Highlighting may include providing a border around the specified portion. The magnification of the specified portion may be nonlinear, so as to create a fisheye appearance. Magnifying or highlighting the specified portion of the user interface that is currently being configured by a user, for example, allows the user to have a clear correlation between the changes that are being made, and the area to which the modified settings will apply. In addition to establishing a clear correlation, magnifying or highlighting the specified portion also draws a user's attention to that portion of the user interface. Many times, the user may not be aware of where the changes are being made on the user interface. Visually emphasizing this area brings the user's attention to that area.

Visually emphasizing a specified portion may also include animations to further draw a user's attention. For instance, the border of the specified portion may change color or shape. In another instance, highlighting applied to or surrounding the specified portion may change color or transparency. In yet another instance, the magnification may change in size. In addition, the position on the display of the emphasized view may change while the specified portion is visually emphasized. As described, there are many techniques for visually emphasizing a specified portion. Thus, techniques not mentioned herein are contemplated to be within the scope of the present invention.

In one embodiment, the specified portion is emphasized incident to receiving some type of indication from a user that the user wishes to configure the specified portion of the user interface. In another embodiment, however, the specified area is emphasized incident to a user actually making the modifications to the configuration of that particular specified portion. In yet another embodiment, the specified area may be emphasized only upon the user making the desired modifications to the configuration within a control panel, and the control being closed. In this embodiment, an indication may be received that the configuration selection is complete, and the set of configuration options for the specified portion may be removed from the user interface (e.g., the control panel is closed). Once the configuration for the specified portion is removed from the display, the specified portion may then be emphasized (e.g., magnified, highlighted) to create the emphasized view of the specified portion. Here, the emphasized view of the specified portion may be displayed with the effects of the configuration selections.

At step 240, a configuration selection for the specified portion of the user interface is received. As previously discussed, a set of configuration options may be presented to a user so that the user may modify or customize a specified portion of the user interface. For example, a user may choose an option that combines multiple instances of a single application into one icon on a taskbar (e.g., gloming). The emphasized view of the specified portion is displayed at step 250, wherein the emphasized view of the specified portion is displayed with the effects of the configuration selection. Using the example above, if a user selects a configuration option to combine multiple instances of a single application into one icon on a taskbar, the emphasized view of the specified portion will display the effects of that selection. As discussed above, the emphasizing of the specified portion, and thus the display of the changes, may occur at different times. In many embodiments, if a specified portion has been emphasized, the changes will be displayed on the emphasized view of the specified portion incident to the configuration selection being received.

In one embodiment, when a specified portion is emphasized, whether the emphasized view overlaps, is offset to, or located elsewhere on the display, any state changes that may effect the specified portion may be displayed. For example, if the specified portion is a notification area, and the system notices that the computer is no longer connected to the network while the specified portion is emphasized, a network connection icon may notify the user while the notification area is displayed in its emphasized view (e.g., magnified). Therefore, any changes that may normally occur to a specified portion may also occur in real-time while the specified portion is emphasized.

The emphasized view of the specified portion may be reverted to an original view of the specified portion. In one instance, this may happen after the user has completed modifying the configuration of the specified portion, and when the configuration of the specified portion is no longer visible to the user on the display. In another instance, if the specified portion is not emphasized until the configuration modifications have been made and the configuration is no longer visible on the display (e.g., the control panel has been closed), the emphasized view of the specified portion may be reverted to the original size after a pre-determined amount of time, such that the user has ample time to view the changes that have been made to the specified portion.

With continued reference to FIG. 2, in some embodiments, the emphasized view of the specified portion may be a separate portion of the user interface that may be located at some location on the display. For example, the emphasized view may be displayed over the specified portion (e.g., overlapping the normal placement of the specified portion), offset in relation to the specified portion, or near the area where the configuration options are displayed. In one instance, if the specified portion is magnified, the magnified view of the specified portion may overlay the specified portion, such that the specified portion is not visible to the user. Here, the effects of the configuration selections may be displayed on the magnified view of the specified portion. In another instance, the magnified view of the specified portion may be located on the display such that the specified portion and the magnified view of the specified portion are both visible to the user. The effects of the configuration selections may be displayed on both the specified portion and the magnified view of the specified portion.

Referring now to FIG. 3, a flow diagram is illustrated which shows a method 300 for bringing visual emphasis to reduced size portions of a total available area of a user interface, in accordance with an embodiment of the present invention. Initially, a user indication to configure one or more specified portions of the user interface is received at step 310. As described above in regard to FIG. 2, the specified portion of the user interface may include any portion that is able to be modified or customized, such as, but not limited to, a notification area (e.g., system tray), an application desktop bar (e.g., taskbar), or any other area that has icons or buttons (e.g., toolbar). In one embodiment, a user may be able to modify more than one portion of a user interface at one time.

At step 320, one or more configuration options for the one or more specified portions of the user interface are displayed on the user interface. These options may vary depending on the specified portion. For instance, if the specified portion is a taskbar, a user may be presented with multiple configuration options, and may be able to customize it in many ways, including locking or unlocking the taskbar, hiding at least a portion of the taskbar from the user interface, removing at least a portion of the tasks associated with the taskbar so that some are hidden or even combined with other tasks (e.g., gloming), changing the position of the taskbar on the display, resizing the height or width of the taskbar, etc.

Incident to displaying the set of configuration options for the specified portion of the user interface, the specified portion is magnified in size at step 330. In this embodiment, the magnification occurs incident to the display of the set of configuration options. For example, a user may open a control panel that has multiple configuration options. Once the control panel is open and configuration options for a specified portion are displayed, the specified portion may be magnified. As was described in step 230 of FIG. 2, there may be a separate magnified view of the specified portion that may overlay the specified portion, or that may be located in a different location on the display than the specified portion. In some embodiments, if the magnified view of the specified portion is positioned separately from the specified portion, the effects of the configuration selections may appear on both the magnified view of the specified portion and the specified portion itself.

At step 340, the configuration selections for the specified portions of the user interface are received. In one instance, a user may make one configuration selection, but in another instance, the user may make more than one configuration selection to modify or customize the specified portion. As described above in regard to step 320, configuration selections may modify a taskbar, for example. These configuration selections may be modifying the height or width of the taskbar, locking or unlocking the taskbar, etc. As another example, if the specified portion is a notification area, such as a system tray, a user may be able to make several configuration selections, including, but not limited to, hiding one or more of the icons, such as when the program, application, or system corresponding to the icon is inactive, or displaying the clock.

Step 350 indicates that incident to receiving configuration selections, the specified portions are displayed with the effects of the configuration selections. Using the previous example, if the specified portion is a system tray, and the user has selected to not show the time within this area, the time may be removed from the magnified view of the specified portion. At step 360, a user indication to complete the configuration of the specified portion of the user interface is received. A user indication to complete configuration may consist of the user closing the control panel window, for example. Next, the size of the specified portion may be reverted to its original size at step 370, as it was prior to the magnification of the specified portion.

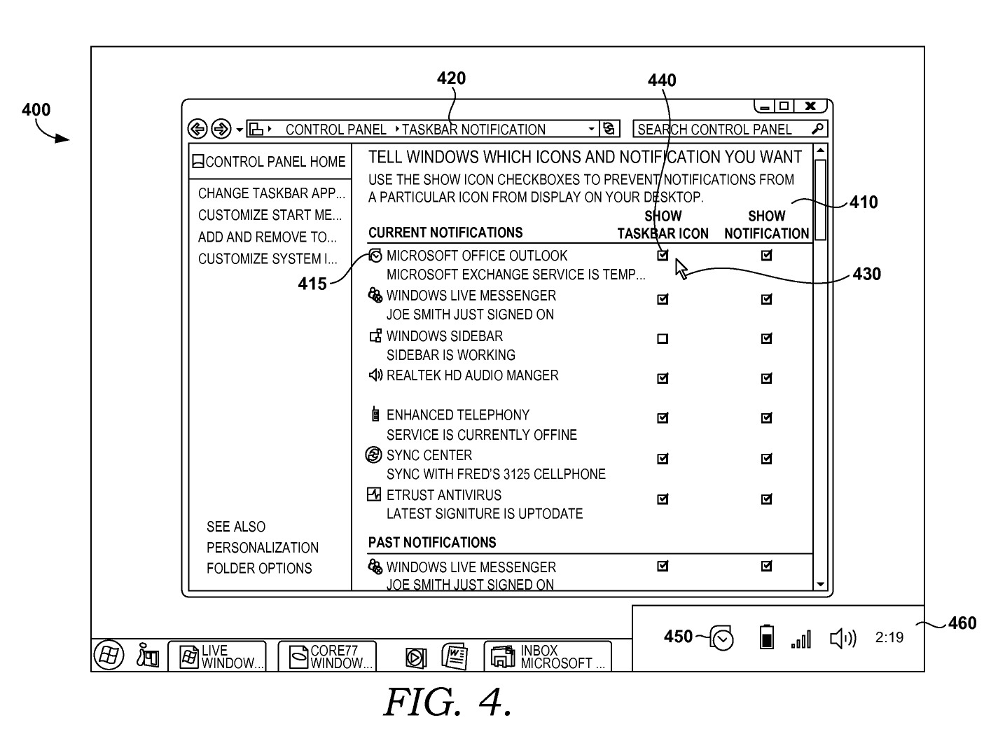

With reference to FIG. 4, an illustrative screen display is shown in accordance with an embodiment of the present invention. The illustrative screen display is an exemplary user interface 400 showing customization of a notification area and a corresponding magnified view of a notification area, in accordance with an embodiment of the present invention. As previously mentioned, a specified portion, such as a notification area, may be emphasized in many ways including, but not limited to magnifying the specified portion, highlighting the specified portion, or highlighting an area surrounding the specified portion (e.g., displaying a border around the specified portion). Item 410 is a user interface of a control panel, which illustrates a set of configuration options for multiple applications, systems, and programs. More specifically, the first application 415 is Microsoft® OUTLOOK. The user, in this embodiment, has two options. The first option is to show an icon for Microsoft® OUTLOOK in the notification area. The second option is to show notifications corresponding to Microsoft® OUTLOOK, such as status notifications. For example, a status notification may be that Microsoft® Exchange Service is temporarily interrupted.

Item 420 illustrates a box that indicates for which specified portion of the user interface corresponds to the displayed set of configuration options. In FIG. 4, box 420 indicates that a set of configuration options for taskbar notification (e.g., notification area) are displayed. Item 430 is a mouse pointer pointing to a checked box 440. Checked box 440 indicates that a user has selected to show the Microsoft® OUTLOOK icon in the notification area. The Microsoft® OUTLOOK icon 450 is illustrated within the magnified view of the notification area 460.

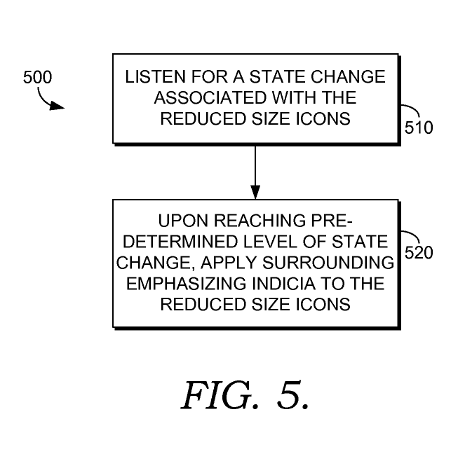

Turning now to FIG. 5, a flow diagram is illustrated of a method 500 for bringing visual emphasis to a reduced size icon, in accordance with an embodiment of the present invention. Reduced size icons may be, but are not limited to, icons in a toolbar, application desktop bar (e.g., taskbar), or notification area (e.g., system tray). Typically, these icons are relatively small, and may not be easily noticed by a user. This may be especially important in the case where the user needs to take an action associated with a critical state, for example, of an application, system, or program. At step 510, the software listens for a state change associated with one or more reduced size icons on a user interface. A state change may be a critical state of an application or program corresponding to the icon. A critical state may include, but is not limited to, low battery level, the need to update a program (e.g., virus software), or loss of an internet or network connection. Also, a state change may occur for a taskbar icon or button, for example, that may be communicating to a user that a change has occurred in the window associated with that icon.

Step 520 indicates that upon reaching a pre-determined level of state change, a surrounding emphasizing indicia is applied to the reduced size icon. In some embodiments, there may be more than one reduced size icon that has a surrounding emphasizing indicia at one time, depending on the critical state of each application or program corresponding to the reduced sized icons at a particular time. A pre-determined level of state change may be a different form or different value, depending on the type of system, application or program associated with a particular reduced size icon. For instance, an icon representing the amount of battery charge in a computing device's battery may have multiple pre-determined levels of state change, such as one at 15%, and a second at 5%, for example. In this instance, one or more of these levels of state change may correspond to the application of a surrounding emphasizing indicia to the battery icon, which may be located in a notification area. In another instance, an icon may be representing a program running on a computing device that may require updates after a pre-determined amount of time, or when updates are available. Here, the pre-determined level of state change for the program may be once an update is ready for a user to download. As such, any system, program, or application may correspond to a reduced size icon on a user interface, and each may have a pre-determined level of state change associated with it.

With continued reference to FIG. 5, a surrounding emphasizing indicia may take many forms. In one embodiment, a backdrop glow is applied to a reduced size icon to create the effect of a glowing icon, which may capture a user's attention in a non-distracting way. Other surrounding emphasizing indicia are also contemplated to be within the scope of the present invention, as one skilled in the art will recognize that there are other forms of surrounding emphasizing indicia that may be used to capture a user's attention in a non-distracting way. In many embodiments, although the icon has a surrounding emphasizing indicia, such as a backdrop glow, the icon will continue to function as a live icon, displaying any status changes that it would normally display.

In one embodiment of FIG. 5, upon the critical state no longer being valid (e.g., user no longer using battery power, user downloaded updated software, computing device now connected to a network or internet), the surrounding emphasizing indicia may be removed from the reduced size icon. In addition, reduced size icons often are given overlays to indicate various states of the corresponding system, application or program. For example, when a battery level is low and has reached a critical state, a small exclamation point may appear over or near a portion of the battery icon in the notification area. The surrounding emphasizing indicia may still be displayed, even when there is an overlay.

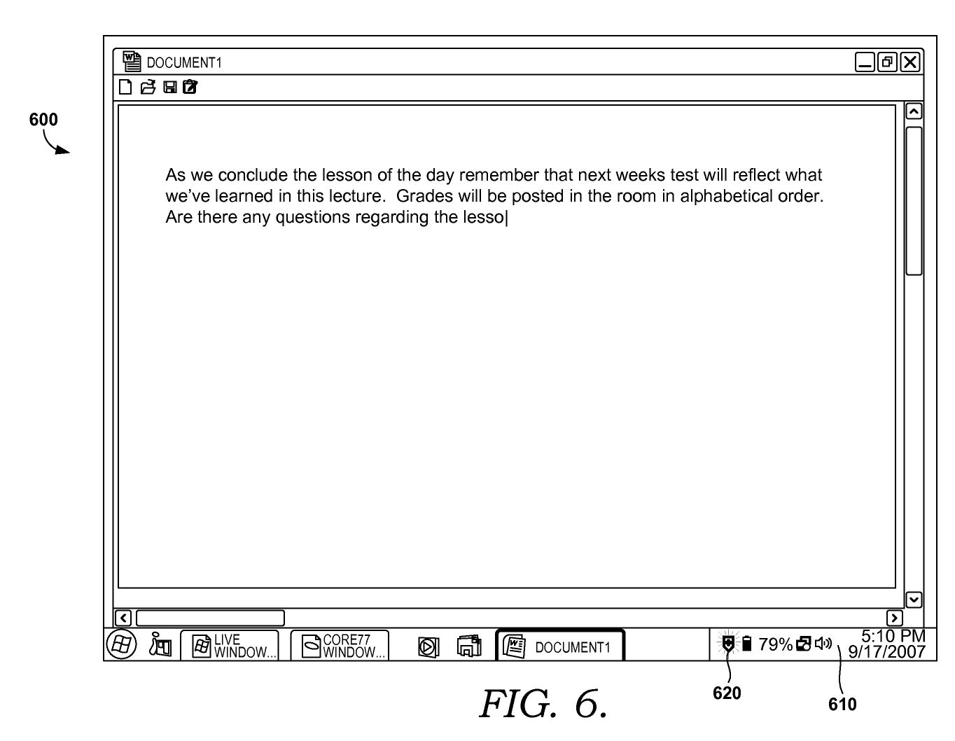

FIG. 6 is an illustrative screen display of an exemplary user interface 600 showing a notification area with a reduced size icon having a surrounding emphasizing indicia. The application of the surrounding emphasizing indicia is a result of a pre-determined level of state change, in accordance with an embodiment of the present invention. Item 610 is a notification area, or a system tray that contains multiple reduced size icons, each of which correspond to a system, application or program on a computing device. One of the reduced size icons, item 620, is illustrated with a surrounding emphasizing indicia, or specifically, a background glow. If reduced size icon 620 corresponds to a virus protection program, for example, the background glow may have been applied upon the determination that an update is ready for the user to download to the user's computing device.

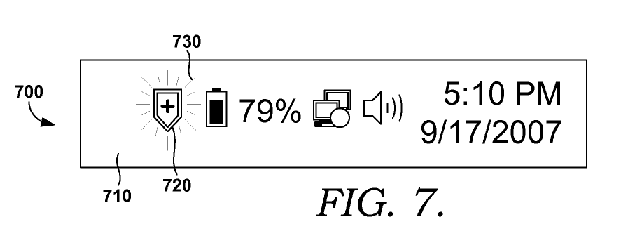

Referring now to FIG. 7, an enlarged view 700 of a portion of the illustrative screen display of FIG. 6 is shown, illustrating a notification area with a reduced size icon having a surrounding emphasizing indicia, in accordance with an embodiment of the present invention. The notification area 710 contains multiple reduced size icons, including reduced size icon 720. As described above in regard to FIG. 6, item 720 may correspond to a virus protection program that may have reached a pre-determined level of state change. This state change may be an update ready for a user to download onto the user's computing device. Upon the pre-determined level of state change, a surrounding emphasizing indicia 730, such as a backdrop glow, may be applied to the reduced size icon to draw the user's attention to the matter requiring attention, but in a non-distracting way.

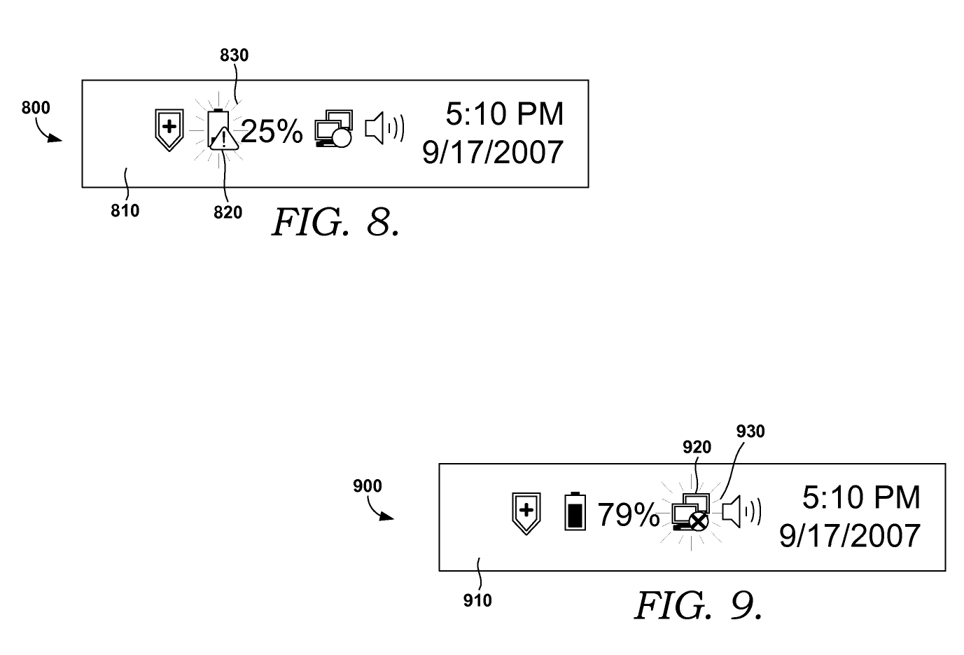

FIG. 8 illustrates an enlarged view 800 of a portion of an illustrative screen display, showing a notification area with a reduced size icon having a surrounding emphasizing indicia, in accordance with an embodiment of the present invention. Similar to FIG. 7, FIG. 8 illustrates notification area 810 with multiple reduced size icons, such as reduced size icon 820. In the embodiment of FIG. 8, the icon represents the amount of battery charge for the computing device. As illustrated, there is an overlay (e.g., exclamation point within triangle) that may also appear on or near the reduced size icon in certain cases. The surrounding emphasizing indicia in this embodiment is backdrop glow 830.

FIG. 9 illustrates another enlarged view 900 of a portion of an illustrative screen display, showing a notification area with a reduced size icon having a surrounding emphasizing indicia, in accordance with another embodiment of the present invention. Here, the notification area 910 contains several reduced size icons, including reduced size icon 920 having a surrounding emphasizing indicia 930, which, in this embodiment, is a backdrop glow. The reduced size icon in the embodiment of FIG. 9 represents the status of a network connection. As illustrated, the reduced size icon 920 incorporates an overlay, which is the “x” symbol, indicating that a network connection is not currently established. The pre-determined level of state change for a reduced size icon such as 920 may be the loss of a network connection, in which at that time, the surrounding emphasizing indicia 930 may appear.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the methods. It will be understood that certain features and sub-combinations are of utility and may be employed without reference to other features and sub-combinations. This is contemplated by and is within the scope of the claims.

What is claimed is:

1. A computer-implemented method for bringing visual emphasis to reduced size portions of a total available area of a user interface, the method comprising:
receiving an indication to configure a specified portion of the user interface;
displaying on the user interface a set of configuration options for the specified portion;
visually emphasizing the specified portion of the user interface, wherein visually emphasizing the specified portion comprises one or more of magnifying in size the specified portion, highlighting the specified portion, or highlighting an area around the specified portion, and wherein visually emphasizing the specified portion creates an emphasized portion;
receiving a configuration selection for the specified portion of the user interface; and
displaying the emphasized view of the specified portion with effects of the configuration selection.

2. The method of claim 1, further comprising:
reverting the emphasized view of the specified portion to an original view of the specified portion.

3. The method of claim 1, wherein the emphasized view of the specified portion overlays the specified portion so that the specified portion is not visible on the user interface.

4. The method of claim 1, wherein the emphasized view of the specified portion is displayed at a different location on the user interface than the specified portion so that both the emphasized view of the specified portion and the specified portion are visible on the user interface.

5. The method of claim 4, wherein the effects of the configuration selection are displayed on both the emphasized view of the specified portion and the specified portion.

6. The method of claim 1, wherein the specified portion is not visible on the user interface prior to receiving an indication to configure the specified portion of the user interface.

7. The method of claim 1, wherein the specified portion is one or more of a toolbar, an application desktop bar, or a notification area.

8. The method of claim 1, wherein visually emphasizing the specified portion of the user interface occurs incident to receiving the indication to configure the specified portion of the user interface.

9. The method of claim 1, wherein visually emphasizing the specified portion of the user interface occurs incident to receiving the configuration selection for the specified portion of the user interface.

10. The method of claim 1, further comprising:
receiving the indication that the configuration selection is complete; and
removing the set of configuration options for the specified portion from the user interface.

11. The method of claim 10, further comprising:
upon removing the set of configuration options for the specified portion from the user interface, visually emphasizing the specified portion of the user interface to create an emphasized view, wherein the emphasized view of the specified portion is displayed with the effects of the configuration selection.

12. The method of claim 1, wherein the set of configuration options is displayed within a control panel.

13. The method of claim 1, wherein the indication is a user indication.

14. One or more computer-readable media having computer-executable instructions embodied thereon that, when executed, perform a method for bringing visual emphasis to a reduced size icon, the method comprising:
listening for a state change associated with one or more reduced size icons on a user interface; and
upon reaching a pre-determined level of state change, applying a surrounding emphasizing indicia to the one or more reduced size icons.

15. The method of claim 14, wherein the surrounding emphasizing indicia is a backdrop glow.

16. The method of claim 14, wherein the one or more reduced size icons are located in a system tray.

17. The method of claim 14, wherein the pre-determined level of state change corresponds to a critical state associated with the one or more reduced size icons.

18. The method of claim 17, further comprising:
upon the critical state no longer being valid, removing the surrounding emphasizing indicia from the one or more reduced size icons.

19. The method of claim 17, wherein the critical state corresponds to a low battery level.

20. A computer-implemented method for bringing visual emphasis to reduced size portions of a total available area of a user interface, the method comprising:
receiving a user indication to configure one or more specified portions of the user interface;
displaying on the user interface a set of configuration options for the one or more specified portions of the user interface;
incident to displaying the set of configuration options for the one or more specified portions of the user interface, magnifying in size the one or more specified portions of the user interface;
receiving one or more configuration selections for the one or more specified portions of the user interface;
incident to receiving the one or more configuration selections, displaying in the one or more specified portions effects of the one or more configuration selections;
receiving the user indication to complete configuration of the one or more specified portions of the user interface; and
reverting the size of the one or more specified portions to an original size.
